(19) United States
(12) Patent Application Publication
(10) Pub. No.: US 2025/0003870 A1
(43) Pub. Date: Jan. 2, 2025

(54) CAMERA ARRANGEMENT FOR A VEHICLE, AND VEHICLE

(71) Applicant: Daimler Truck AG, Leinfelden-Echterdingen (DE)

(72) Inventor: Fridtjof STEIN, Ostfildern (DE)

(21) Appl. No.: 18/701,149

(22) PCT Filed: Oct. 12, 2022
(86) PCT No.: PCT/EP2022/078444

§ 371 Date: Apr. 12, 2024

(30) Foreign Application Priority Data
Oct. 26, 2021 (DE) 10 2021 005 334.6

(51) Int. Cl. G01N 21/3554; B60W 50/14; H04N 23/51; H04N 23/52

(52) U.S. Cl. CPC G01N 21/3554; B60W 50/14; H04N 23/51; H04N 23/52; B60W 2300/12; B60W 2420/403; G01N 2201/0216; G01N 2201/0238

(57) ABSTRACT

The invention relates to a camera arrangement (K) for a vehicle with at least one camera (1) arranged in a housing (2), wherein the housing (2) has at least one transparent region. The camera arrangement (K) according to the invention is characterised by
a container (5) which is arranged in the housing (2) and has a moisture-adsorbing drying agent (6), wherein the container (5) has a permeable membrane (7) on at least one side, such that an air exchange (LA) takes place between an interior of the housing (2) and the drying agent (6), and
a detection unit (8) coupled to the container (5) for detecting a state of the drying agent (6).

The invention relates to a camera arrangement for a vehicle with at least one camera arranged in a housing, wherein the housing has at least one transparent region.

Furthermore, the invention relates to a vehicle with such a camera arrangement.

A camera arrangement for a vehicle is known from DE 10 2009 019 216 A1. The camera arrangement comprises a camera holder for fixing a camera behind a pane of vehicle glazing in a vehicle interior, wherein a spatial region is formed by the pane, the camera, and the camera holder. A heated region of the pane is provided in a viewing region of the camera and at least one unheated condensation element is provided in the spatial region for targeted condensation of water which has evaporated in the viewing region.

Furthermore, silica gel, also known as silicic acid gel, is commonly known as a drying agent. Silica gel as a drying agent adsorbs water on its comparatively large interior surface and is often included in moisture-sensitive shipments.

The invention is based on the object of specifying a novel camera arrangement for a vehicle and a vehicle with such a camera arrangement.

The object is solved according to the invention by the features specified in claim 1 regarding the camera arrangement and by the features specified in claim 7 regarding the vehicle.

Advantageous embodiments of the invention are the subject matter of the dependent claims.

A camera arrangement for a vehicle has at least one camera arranged in a housing, wherein the housing has at least one transparent region. According to the invention, a container which is arranged in the housing and has a moisture-adsorbing drying agent is provided, wherein the container has a permeable membrane on at least one side, such that an air exchange takes place between an interior of the housing and the drying agent. Furthermore, the camera arrangement has a detection unit coupled to the container for detecting a state of the drying agent.

By means of the drying agent arranged in the container and due to the air exchange between the interior of the housing and the drying agent, as far as possible a relatively dry interior atmosphere can be guaranteed in the housing, since any moisture that arises is adsorbed by the drying agent. Therefore, as far as possible, this relatively dry interior atmosphere can also be maintained when the vehicle is switched off, i.e. the vehicle is at standstill. By adsorbing moisture, it is relatively dry in the housing, such that the risk of the electronics and mechanics of the camera arrangement corroding can be at least significantly reduced. The electronics and mechanics are thus continuously protected from corrosion as far as possible.

By means of the drying agent, misting up of the transparent region, i.e. of a viewing window through which the at least one camera records image data from outside the housing, can substantially be avoided, in particular when starting the vehicle, as a dry interior atmosphere prevails as far as possible due to the drying agent.

Because a state of the drying agent, in particular in relation to its moisture-absorption capacity is detected by means of the detection unit, it is possible to replace the drying agent as required in order to optimise the absorption capacity of the drying agent. Thus, it can be ensured as far as possible that a dry interior atmosphere prevails in the housing.

In an embodiment of the camera arrangement, the detection unit is designed to record a saturation and/or a loading of the drying agent as a state. As the saturation is recorded, it is then possible to replace the drying agent so that an adsorption of moisture is optimised in the housing of the camera by means of the replaced and in particular renewed drying agent.

A further embodiment of the camera arrangement provides that the drying agent is designed to change colour depending on its loading. The drying agent changes its colour depending on its state, wherein this colour change can be recorded by means of the detection unit and thus a current adsorption capacity of the drying agent can be established.

To this end, the detection unit in one embodiment has at least one light source emitting a white light, at least one colour sensor and an analysis unit coupled to the colour sensor. The drying agent is illuminated by means of the light source emitting white light, wherein on the basis of recorded signals of the colour sensor, a colour of the drying agent and thus its state can be determined by means of the analysis unit.

In a further possible embodiment, the detection unit is designed to output a warning in the vehicle and/or to transmit a warning to a diagnostic module of the vehicle and/or to a computing unit coupled to the vehicle using data technology when saturation and/or loading of the drying agent is recorded on the basis of the colour change. Thus, an optionally present driver of the vehicle, a workshop and/or a service centre of the vehicle are informed about the lack of adsorption capacity of the drying agent, so that the latter can be replaced promptly to maintain the functionality of the camera.

In a further embodiment, the housing has an opening which can be closed by means of a closure element for removal and replacement of the container. It is possible to remove the container with the stored drying agent from the housing via the closable opening without destruction in order to replace said container.

The invention further relates to a vehicle with a camera arrangement which has at least one camera arranged in a housing with at least one transparent region. In addition, the camera arrangement has the container with the drying agent and the detection unit for detecting a state of the drying agent. Therefore, it is possible to record the saturation of the drying agent as a state, so that the drying agent can be replaced in order to restore or optimise the functionality of the camera, in particular regarding recording the environment surrounding the vehicle.

In one possible embodiment, the vehicle may be a self-driving lorry which drives without a driver and therefore, among other things, a clear view of the camera should be ensured continuously, whereby the safety for the vehicle and road users in an immediate environment of the vehicle can be significantly increased.

Exemplary embodiments of the invention are explained in more detail in the following with the aid of drawings.

Here:

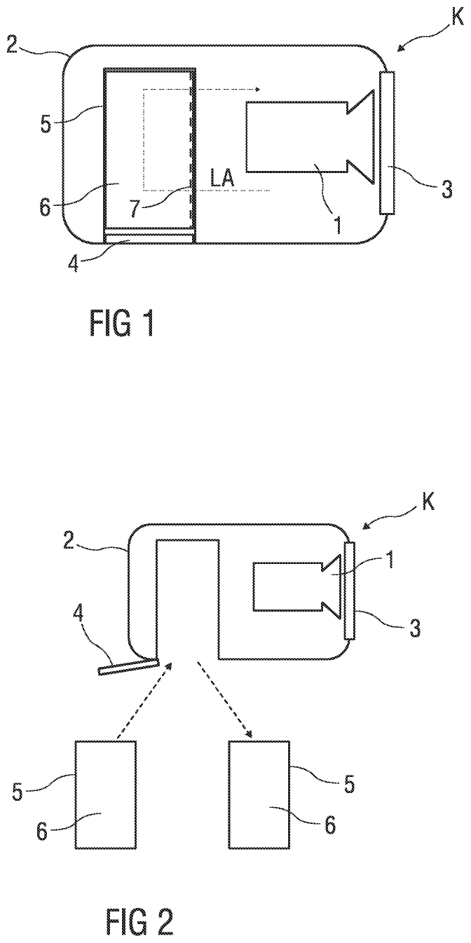

FIG. 1 schematically shows a sectional view of a camera arrangement for a vehicle,

FIG. 2 schematically shows the camera arrangement during a maintenance process,

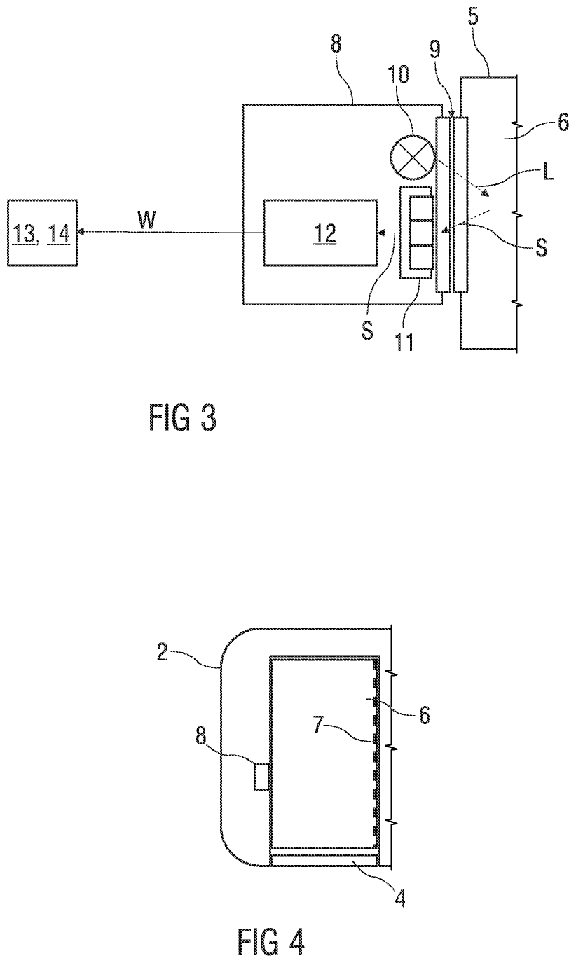

FIG. 3 schematically shows an excerpt of a sectional view of the camera arrangement with a detection unit for detecting a need for maintenance, and

FIG. 4 schematically shows an enlarged excerpt of a sectional view of the camera arrangement in the region of the detection unit.

Parts corresponding to each other are provided with the same reference numerals in all of the figures.

In FIG. 1, a sectional view of a camera arrangement K of a vehicle (not shown in detail), in particular of a commercial vehicle in the form of a lorry, is shown. The vehicle in particular can be moved in the automated driving mode, where the presence of a driver is not required, i.e. the vehicle drives without a driver.

For the automated, particularly autonomous driving mode of the vehicle, perceiving and surveying an environment of the vehicle is mandatory. To this end, the vehicle typically has sensors, e.g. lidar-based, radar-based and/or ultrasound-based.

An arrangement of this sensor represents a relatively great challenge. Due to installation space reasons, not all of the sensors can be arranged in a protected and comparatively easy to clean region in the vehicle behind a windscreen. Also, for functional reasons, not every sensor can be arranged behind the windscreen, as it is possible that a sensor functions in a frequency band which is incompatible with a material of the windscreen. There is thus an absorption problem here.

A separate housing 2 for individual or combined sensors is a possible solution for arranging the sensor or the sensors on the outside of the vehicle. With such housings 2, it is comparatively complex to be able to protect the sensors encapsulated by means of the housing 2 from environmental influences. Along with setting certain temperatures, in particular for cooling and heating, moisture is a comparatively great problem. Depending on how well the respective sensor is encapsulated by means of the housing 2, moisture usually finds a way into the housing 2. Additionally, temperature fluctuations lead to condensation and therefore, e.g., to corrosion of electronics and mechanics as well as misting up of a viewing window 3 of the housing 2.

As the self-driving vehicle is constantly being maintained, relatively cost-effective possibilities arise in relation to a design of the housing 2 of the camera arrangement K. To be able to ensure the functionality of the camera arrangement K as far as possible, in particular of a camera 1 as an optical sensor of the camera arrangement K, the camera arrangement K is designed as described in the following.

The camera arrangement K has at least one camera 1 which is arranged in the housing 2 with the viewing window 3 as a transparent region and a closure element 4. Furthermore, the camera arrangement K has a container 5 with a drying agent 6 in the form of silica gel, which is also referred to as silicic acid gel, and/or another suitable granulated material.

A side wall of the housing 2, in particular a side wall facing towards the camera 1, is formed by a permeable membrane 7, via which an air exchange LA between an interior of the housing 2 and an interior of the container 5 and thus the drying agent 6 is possible.

The drying agent 6 is arranged in the housing 2 to adsorb the moisture present in the housing 2, in order to prevent misting up of the viewing window 3 and corrosion of the electronics and mechanics of the camera arrangement K, as far as possible.

If an adsorption capacity of the drying agent 6 is reduced, it is possible to remove the container 5 with the drying agent 6 from the housing 2 and replace it without significant effort via the closure element 4. For example, the container 5 is replaced during regular maintenance of the vehicle and/or when the drying agent 6 is saturated, i.e. has retained too much moisture, as shown in FIG. 2.

In order to determine a necessity for the replacement of the drying agent 6, a detection unit 8 is arranged in the housing 2, as shown in FIGS. 3 and 4. Here, an enlarged section of the detection unit 8 coupled to the container 5 is represented in FIG. 3, with an enlarged section of a sectional view of the camera arrangement K in the region of the detection unit 8 being shown in FIG. 4. In particular, the detection unit 8 is coupled to the container 5 via a further viewing window 9.

The detection unit 8 has a light source 10 emitting a white light L, a colour sensor 11 and an analysis unit 12 coupled to the colour sensor 11. The drying agent 6 stored in the container 5, in particular in the form of the silica gel, is coloured and has a blue colour in the unsaturated state. If a state of the drying agent 6 approaches saturation based on a quantity of adsorbed moisture, the drying agent 6 turns orange, for example. Therefore, the respective colour represents an indicator for a state of the drying agent 6.

The light source 10 emits white light L for example continuously or at regular intervals, e.g. at the start of the journey and at the end of the journey. Radiation reflected by the drying agent 6 is recorded as a signal S by the colour sensor 11 and is supplied to the analysis unit 12, which is electronic measurement equipment, for analysis.

On the basis of the determined colour of the drying agent 6, the state thereof is specified and when saturation, i.e. loading, of the drying agent 6 is recorded, the analysis unit 12 generates a warning W. This warning W is output in the vehicle, transmitted to a diagnostic module 13 and/or to a computing unit 14 coupled to the vehicle using data technology.

A respective receiver of the warning W is thus informed about the determined state of the drying agent 6 of the camera arrangement K and thus can comparatively promptly cause the drying agent 6 to be replaced, to ensure the functionality of the camera arrangement K, particularly of the camera 1, as far as possible.

Such a camera arrangement K enables a comparatively fast and simple replacement of the drying agent 6, wherein the replacement can be carried out for example by a robot.

The camera arrangement K can be produced relatively cost-effectively, as a relatively cost-effective encapsulation is not required any more, as the drying agent 6 immediately retains any moisture penetrating the housing 2, so that formation of condensation can also be ruled out, as far as possible.

1. Camera arrangement (K) for a vehicle with at least one camera (1) arranged in a housing (2), wherein the housing (2) has at least one transparent region, characterised by
a container (5) which is arranged in the housing (2) and has a moisture-adsorbing drying agent (6), wherein the container (5) has a permeable membrane (7) on at least one side, such that an air exchange (LA) takes place between an interior of the housing (2) and the drying agent (6), and
a detection unit (8) coupled to the container (5) for detecting a state of the drying agent (6).

2. Camera arrangement (K) according to claim 1,
characterised in that the detection unit (8) is designed to record a saturation and/or loading of the drying agent (6) as a state.

3. Camera arrangement (K) according to claim 1 or 2,
characterised in that the drying agent (6) is designed to change colour depending on its loading and the detection unit (8) is designed to record the state of the drying agent (6) on the basis of its colour change.

4. Camera arrangement (K) according to one of the preceding claims,
characterised in that the detection unit (8) has at least one light source (10) emitting white light (L), at least one colour sensor (11) and an analysis unit (12) coupled to the colour sensor (11).

5. Camera arrangement (K) according to one of the preceding claims,
characterised in that the detection unit (8) is designed to output a warning (W) in the vehicle and/or to transmit a warning (W) to a diagnostic module (13) of the vehicle and/or to a computing unit (14) coupled to the vehicle using data technology when saturation and/or loading of the drying agent (6) is recorded on the basis of the colour change.

6. Camera arrangement (K) according to one of the preceding claims,
characterised in that the housing (2) has an opening which can be closed by means of a closure element (4) for removal and replacement of the container (5).

7. Vehicle with a camera arrangement (K) according to one of claims 1 to 6.

8. Vehicle according to claim 7,
characterised in that the vehicle is a self-driving lorry.
